(19) United States
(12) Patent Application Publication
(10) Pub. No.: US 2008/0143625 A1
(43) Pub. Date: Jun. 19, 2008

(54) ANTENNA SHEET AND MANUFACTURING METHOD THEREFOR

(76) Inventors: Takao Mizushima, Niigata-ken (JP); Hideyuki Takahashi, Niigata-ken (JP); Akira Sakai, Niigata-ken (JP)

Correspondence Address: BRINKS HOFER GILSON & LIONE, P.O. BOX 10395, CHICAGO, IL, 60610, US

(21) Appl. No.: 11/950,019

(22) Filed: Dec. 4, 2007

(30) Foreign Application Priority Data
Dec. 18, 2006 (JP) 2006-339690

(51) Int. Cl. H01Q 1/00; H01P 11/00

(52) U.S. Cl. 343/787; 29/600; 977/773

(57) ABSTRACT

An antenna sheet includes a magnetic sheet composed of a resin matrix and an Fe-based amorphous alloy contained in the resin matrix, and an antenna pattern disposed directly on the magnetic sheet, the antenna pattern being composed of nanoparticles. The antenna sheet can be manufactured by forming the antenna pattern directly on the magnetic sheet using a material containing nanoparticles, and then by sintering the nanoparticles by subjecting the magnetic sheet having the antenna pattern to heat treatment.

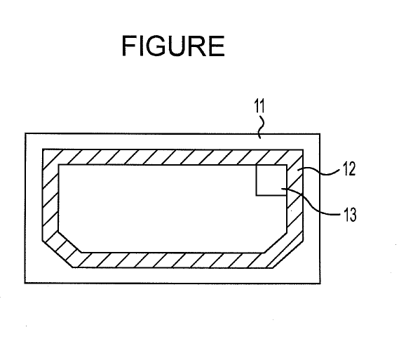

### CLAIM OF PRIORITY

This application claims benefit of the Japanese Patent Application No. 2006-339690 filed on Dec. 18, 2006, the entire content of which is hereby incorporated by reference.

### BACKGROUND OF THE INVENTION

1. Field of the Invention

The present invention relates to antenna sheets and manufacturing methods therefor. More particularly, the invention relates to an antenna sheet for contactless communication and a manufacturing method therefor.

2. Description of the Related Art

In recent years, mobile terminals, such as cellular phones, have become more widely used and more sophisticated, and mobile terminals capable of contactless communication have also been developed. In contactless communication, a contactless communication unit including an antenna and an IC for contactless communication is required in order to communicate with an external reader/writer (R/W). Usually, such a contactless communication unit is mounted on a mobile terminal or the like capable of contactless communication.

However, in a mobile terminal, a metal plate (shield plate) is often disposed on the back of a contactless communication unit. In such a structure, in some cases, magnetic fluxes generated from an antenna may be inhibited by reactive magnetic fluxes caused by an eddy current generated in the metal plate, thus affecting contactless communication. Consequently, a magnetic sheet is placed between the contactless communication unit and the metal plate to suppress the influence of the metal plate (refer to Japanese Unexamined Patent Application Publication No. 2002-246786).

As mobile terminals become more sophisticated, the number of components and modules mounted thereon increases. On the other hand, reduction in size and thickness is desired. Placing the magnetic sheet separately as described above results in an increase in thickness, which runs counter to the required reduction in thickness.

### SUMMARY

The present invention provides an antenna sheet which can be used in a contactless communication unit and which does not increase the thickness of a device mounted, and a method for manufacturing the antenna sheet.

According to an aspect of the present disclosure, an antenna sheet includes a magnetic sheet composed of a resin matrix and an Fe-based amorphous alloy contained in the resin matrix, and an antenna pattern disposed directly on the magnetic sheet, the antenna pattern being composed of nanoparticles.

In such an arrangement, the antenna sheet can be used in a contactless communication unit, and the antenna sheet does not increase the thickness of a device mounted.

In the antenna sheet, preferably, the magnetic sheet has been subjected to annealing treatment. In such an arrangement, it is possible to form a particularly highly conductive antenna pattern in which nanoparticles are sintered.

According to another aspect of the present invention, a method for manufacturing an antenna sheet includes the steps of forming into a sheet a mixture of a resin material and an Fe-based amorphous alloy, producing a magnetic sheet by subjecting the sheet to annealing treatment, forming an antenna pattern directly on the magnetic sheet using a material containing nanoparticles, and sintering the nanoparticles by subjecting the magnetic sheet having the antenna pattern to heat treatment.

Preferably, the method for manufacturing the antenna sheet further includes, before the formation of the antenna pattern, the step of subjecting the magnetic sheet to corona discharge treatment.

### BRIEF DESCRIPTION OF THE DRAWING

FIGURE is a schematic diagram showing an example of an antenna sheet according to an embodiment.

### DESCRIPTION OF THE EMBODIMENTS

The present inventors have found that when a magnetic sheet containing an Fe-based amorphous alloy is subjected to annealing treatment to improve the magnetic properties of the Fe-based amorphous alloy, a resin matrix material is gelled and then cured, and thus the heat resistance of the resulting magnetic sheet is improved. It is known that by sintering nanoparticles by heat treatment of 200° C. or higher, the electrical conductivity thereof is significantly improved. However, resin matrix materials cannot usually withstand heat treatment for sintering nanoparticles. The present inventors have found that with the use of the fact that the heat resistance of the magnetic sheet is improved when the resin matrix material contained in the magnetic sheet is gelled and then cured, by forming an antenna pattern composed of nanoparticles directly on the magnetic sheet and by sintering the nanoparticles by heat treatment, it is possible to obtain a low-profile antenna sheet having a highly conductive antenna pattern, and thus the present invention has been achieved.

The embodiments will be described in detail with reference to the attached drawing.

As shown in FIGURE, an antenna sheet according to an embodiment mainly includes a magnetic sheet 11 composed of a resin matrix and an Fe-based amorphous alloy contained in the resin matrix and an antenna pattern 12 disposed directly on the magnetic sheet 11, the antenna pattern 12 being composed of nanoparticles. An IC 13 is mounted on the magnetic sheet 11 so as to be electrically connected to the antenna pattern 12.

Examples of a resin material constituting the resin matrix include a silicone resin, polyvinyl chloride, silicone rubber, a phenolic resin, a melamine resin, polyvinyl alcohol, and various elastomers. In particular, considering that a magnetic material is mixed in a resin solution and formed into a sheet, the matrix material is preferably a resin capable of forming an emulsion solution of the magnetic material, for example, a silicone resin or the like. By adding a lubricant containing a stearate salt or the like to the matrix material, the magnetic material can be easily formed into a flat shape, and thus it is possible to obtain a magnetic material having a high aspect ratio. As a result, the magnetic material in the magnetic sheet is easily stacked and oriented in the thickness direction of the sheet, and also the density is increased.

The Fe-based amorphous alloy contained in the magnetic sheet 11 is an Fe—Cr—P—C—B—Si-based alloy, which is an amorphous alloy having a supercooled liquid range. The composition of the Fe-based amorphous alloy can be determined appropriately depending on the characteristics required for the magnetic sheet 11. Furthermore, the content of the Fe-based amorphous alloy in the magnetic sheet 11 can be determined appropriately depending on the characteristics required for the magnetic sheet 11. In view of magnetic permeability and the like, the content of the Fe-based amorphous alloy is preferably about 83% to about 93% by weight.

The Fe-based amorphous alloy used for the magnetic sheet 11 is preferably in the form of flat particles or powder. The aspect ratio (length/thickness) of the flat particles or powder is preferably about 2.5 or more, and more preferably about 12 or more. As the orientations of flat particles or powder become closer to one another, the density of the magnetic sheet itself increases, and the real part μ′ of complex permeability increases. When the aspect ratio is high, generation of eddy current is suppressed, and impedance is increased, resulting in an increase in the real part μ′ of complex permeability in the MHz range.

Examples of the nanoparticles constituting the antenna pattern 12 include silver nanoparticles, gold nanoparticles, and copper nanoparticles with a particle size of about 3 to about 22 nm. The antenna pattern 12 can be formed by pattern printing of a nanopaste, which is prepared by dispersing the nanoparticles in a dispersant, directly on the magnetic sheet 11, and then by firing the nanopaste. When the nanopaste is fired, nanoparticles in the nanopaste are fused together or agglomerated, i.e., sintered. Thereby, the conductivity of the magnetic sheet 11 can be improved.

A method for manufacturing an antenna sheet according to an embodiment of the present invention includes the steps of forming into a sheet a mixture of a resin material and an Fe-based amorphous alloy, producing a magnetic sheet by subjecting the sheet to annealing treatment, forming an antenna pattern on the magnetic sheet using a material containing nanoparticles, and sintering the nanoparticles by subjecting the magnetic sheet having the antenna pattern to heat treatment.

First, an Fe-based amorphous alloy powder is produced. In this step, the Fe-based amorphous alloy powder is produced by a water atomization method in which starting materials are weighed so as to attain the composition of a predetermined Fe-based amorphous alloy, followed by mixing and melting, and the molten alloy is quenched by blowing the molten alloy into water. The method for producing the Fe-based amorphous alloy powder is not limited to the water atomization method, and it may also be possible to use a gas atomization method, a liquid quenching method in which the molten alloy is quenched to form a ribbon, and the ribbon is pulverized into a powder, or the like. The water atomization method, the gas atomization method, or the liquid quenching method can be carried out under the conditions that are commonly used according to the type of starting material.

The resulting Fe-based amorphous alloy powder is classified so as to include a predetermined range of the particle size, and then, as necessary, the alloy powder is flattened using an apparatus, such as an attritor. An attritor includes a drum in which many milling balls are placed, and the Fe-based amorphous alloy powder fed into the drum and the balls are mixed by stirring with a stirring rod which is rotatably inserted around the drum shaft so that the Fe-based amorphous alloy powder has a desired degree of flatness. Note that flat particles of the Fe-based amorphous alloy powder can also be obtained by the liquid quenching method described above. According to need, the resulting Fe-based amorphous alloy powder may be subjected to heat treatment in order to relieve internal stress.

Subsequently, a magnetic sheet containing the Fe-based amorphous alloy is produced. In this step, preferably, a mixed solution is prepared by mixing the Fe-based amorphous alloy powder in a liquid of the matrix material constituting the magnetic sheet, and then the mixed solution is formed into a sheet to obtain the magnetic sheet. Then, the magnetic sheet is subjected to annealing treatment. The annealing treatment temperature is preferably 250° C. to 400° C. By subjecting the Fe-based amorphous alloy to annealing treatment, the real part μ′ of complex permeability can be increased.

Preferably, the magnetic sheet is subjected to corona discharge treatment before the formation of an antenna pattern. By performing this treatment, the surface of the magnetic sheet is roughened or activated, and thus adhesion between the magnetic sheet and the antenna pattern can be improved. The corona discharge treatment can be performed, for example, with a gap of 1 mm and at a voltage of 14 kV.

Subsequently, an antenna pattern is formed on the magnetic sheet. The antenna pattern is formed by patterning of a nanopaste prepared by dispersing nanoparticles in a dispersant, using screen printing, ink jet printing, or the like. The thickness of the antenna pattern and the shape of the pattern are not particularly limited.

Next, description will be given on Example carried out in order to clarify the advantage of the present invention.

### EXAMPLE

Powder of a soft magnetic alloy having a composition of Fe_{67.9}Ni₄Cr₄Sn_{3.5}P_{8.8}C_{10.8}B₁ was produced by a water atomization method Fe-based amorphous alloy particles were obtained. Then, 90% by weight of the Fe-based amorphous alloy particles were mixed with a silicone resin, and the mixture was formed into a sheet, thereby producing a magnetic sheet with a thickness of about 0.1 mm. The resulting magnetic sheet was fed into an annealing furnace, and annealing treatment was performed under a nitrogen atmosphere at an annealing temperature of 360° C.

Subsequently, the resulting magnetic sheet was subjected to corona discharge treatment with a gap of 1 mm and at a voltage of 14 kV. Then, a silver nanopaste was screen printed at a thickness of 2 μm on the magnetic sheet. Subsequently, the magnetic sheet was subjected to heat treatment at 240° C. for one hour to sinter silver nanoparticles. Thereby, an antenna sheet of Example was obtained. An IC for contactless communication was mounted on the antenna pattern of the antenna sheet.

The conductor resistance of the antenna sheet was measured with a resistance meter, and the value obtained was 14.3Ω. Furthermore, the induced electromotive force was evaluated assuming use in an antenna unit for cellular phone. The induced electromotive force of the antenna sheet was measured by a method in which the antenna sheet was connected to a spectrum analyzer (RSA3303A) and placed at a position 26 mm away from an R/W emitting a carrier of 13.56 MHz, and the signal strength captured by the antenna pattern was measured. As a result, the signal strength was 9.3 (dBm), which was a level capable of performing contactless communication satisfactorily. The thickness of the antenna sheet was about 0.1 mm, which was half that in the case where a contactless communication unit and a magnetic sheet were used as in the past.

### Comparative Example

A magnetic sheet with a thickness of about 0.1 mm was formed as in Example, and the magnetic sheet was subjected to annealing treatment as in Example. Then, silver paste was screen printed at a thickness of 2 μm on the magnetic sheet. Subsequently, the magnetic sheet was subjected to heat treatment at 120° C. for 30 minutes. Thereby, an antenna sheet of Comparative Example was obtained. An IC for contactless communication was mounted on the antenna pattern of the antenna sheet.

The conductor resistance of the antenna sheet was measured with a resistance meter, and the value obtained was 12.3 MΩ. Furthermore, the induced electromotive force of the antenna sheet was measured as in Example. As a result, the signal strength was −37.8 (dBm), which was a level at which it was impossible to perform contactless communication.

As described above, in the antenna sheet according to the present invention, contactless communication can be performed with satisfactory sensitivity, and reduction in thickness can be achieved.

The present invention is not limited to the embodiments described above, and various modifications thereof are possible. For example, it is possible to modify the type and content of constituent elements, mixing procedures, treatment conditions, printing conditions, and the like, without departing from the scope of the present invention.

What is claimed is:

1. An antenna sheet comprising:
a magnetic sheet composed of a resin matrix and an Fe-based amorphous alloy contained in the resin matrix; and
an antenna pattern disposed directly on the magnetic sheet, the antenna pattern being composed of nanoparticles.

2. The antenna sheet according to claim 1, wherein the magnetic sheet has been subjected to annealing treatment.

3. A method for manufacturing an antenna sheet comprising the steps of:
forming into a sheet a mixture of a resin material and an Fe-based amorphous alloy;
producing a magnetic sheet by subjecting the sheet to annealing treatment;
forming an antenna pattern directly on the magnetic sheet using a material containing nanoparticles; and
sintering the nanoparticles by subjecting the magnetic sheet having the antenna pattern to heat treatment.

4. The method for manufacturing an antenna sheet according to claim 3, further comprising, before the step of forming the antenna pattern, the step of subjecting the magnetic sheet to corona discharge treatment.
